(19) United States
(12) Patent Application Publication
(10) Pub. No.: US 2008/0100618 A1
(43) Pub. Date: May 1, 2008

(54) Method, medium, and system rendering 3D graphic object

(75) Inventors: Sang-oak Woo, Anyang-si (KR); Seok-yoon Jung, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/892,916

(22) Filed: Aug. 28, 2007

(30) Foreign Application Priority Data
Oct. 27, 2006 (KR) 10-2006-0105338

(51) Int. Cl. G06T 15/40

(52) U.S. Cl. 345/421

(57) ABSTRACT

A method, medium, and system rendering a 3-dimensional (3D) object, with the method of rendering a 3D object including generating a scanline of a primitive forming the 3D object, removing some pixels included in the generated scanline in consideration of visibility, thereby reconstructing scanlines, and determining the color of each pixel included in the reconstructed scanline. According to such a method, medium, and system, the efficiency of a 3D object rendering process which is performed using a pipeline method can be enhanced over conventional pipeline implementations.

### CROSS-REFERENCE TO RELATED APPLICATIONS

This application claims the benefit of Korean Patent Application No. 10-2006-0105338, filed on Oct. 27, 2006, in the Korean Intellectual Property Office, the disclosure of which is incorporated herein in its entirety by reference.

### BACKGROUND

1. Field

One or more embodiments of the present invention relate to a method, medium, and system rendering a 3-dimensional (3D) graphic object, and more particularly, to a method, medium, and system improving the efficiency of rendering by reconstructing scanlines transferred to a rasterization operation according to a pipeline method.

2. Description of the Related Art

A rendering process of a 3-dimensional (3D) graphic object can be roughly broken down into a geometry stage and a rasterization stage.

The geometry stage can be further broken down into model transformation, camera transformation, lighting and shading, projecting, clipping, and screen mapping. Model transformation includes a process of transforming a 3D object into the world coordinate system in a 3D space, and a process of transforming the 3D object that is transformed into the world coordinate system to the camera coordinate system relative to a viewpoint (camera), for example. Lighting and shading is a process of expressing a reflection effect and shading effect by a light source in order to increase a realistic effect of the 3D object. Projecting is a process of projecting the 3D object transformed into the camera coordinate system onto a 2D screen. Clipping is a process of clipping part of a primitive exceeding a view volume in order to transfer only the primitive included in the view volume to a rasterization stage. Screen mapping is a process of identifying coordinates at which the projected object is actually output on a screen.

The geometry stage is typically processed in units of primitives. A primitive is a basic unit for expressing a 3D object, and includes a vertex, a line, and a polygon. Among polygons, a triangle is generally used for reasons such as convenience of calculation, as only three vertices are necessary to define a triangle.

The rasterization stage is a process of determining an accurate color of each pixel, by using the coordinates of each vertex, color, and texture coordinates of a 3D object provided from the geometry stage. The rasterization stage includes a scan conversion operation and a pixel processing operation. In the scan conversion operation, by using information of vertices of the input 3D object, a triangle may be set up, and scanlines of the set triangle generated. In the pixel processing operation, the color of each pixel included in the generated scanline is determined. The scan conversion operation includes a triangle set-up process for setting up a triangle, and a scanline formation process for generating scanlines of the triangle. The pixel processing operation includes a texture mapping process, an alpha test, a depth test, and a color blending process.

In general, since the rasterization stage requires a substantial amount of computation, a rendering engine processes the rasterization stage by using a pipeline method in order to improve the speed of processing. The pipeline method is a data processing method in which a series of processes are divided into a plurality of processes so that each divided process can process different data in parallel. This is similar to a process of completing a product, by sequentially assembling a series of blocks on a conveyer belt. In this case, if one of the product blocks is defective and the assembly is stopped in the middle of production, the assembly process cannot proceed and the product cannot be completed. Similarly, if any one process of the plurality of divided processes is stopped, all the following processes after the stopped process also stop. Accordingly, while the processing is stopped, no result can be generated, thereby causing a problem in respect of throughput.

FIG. 1 is a block diagram illustrating a structure of an ordinary rasterization engine according to conventional technology. The rasterization engine includes a scan conversion unit 100 and a pixel processing unit 110. The scan conversion unit 100 includes a triangle setup unit 120 and a scanline formation unit 130. The pixel processing unit 110 includes a texture mapping unit 140, an alpha test unit 150, a depth test unit 160 and a color blending unit 170. Each unit performs a corresponding process in a series of rasterization processes. The rasterization is processed in parallel in these subunits that perform respective processes of the plurality of divided processes, thereby being processed according to a pipeline method.

Problems that may occur when the rasterization is performed according to the pipeline method will now be explained with reference to FIG. 1.

When all pixels included in scanlines of a triangle generated in the scan conversion unit 100 are transferred to the pixel processing unit 110, some pixels from among the transferred pixels fail in depth tests in the depth test unit 160, and cannot be transferred to the color blending unit 170, and thus the rasterization may stop in the depth test unit 160. This is because a pixel that fails in a depth test is a pixel that will not be displayed on a screen, and therefore the pixel does not need to be transferred to the color blending unit 170 in order to determine the color of the pixel.

However, since the subunits 150 through 170 of the pixel processing unit 110 uniformly operate according to a pipeline method, a time required for performing the texture mapping, alpha test, depth test and color blending for each of all input pixels is already allocated. Accordingly, even though a pixel does not pass a depth test and rasterization of the pixel is stopped in the depth test unit 160, the color blending unit 170 can perform a process for determining the color of the next pixel, only after the time allocated for determining the color of the stopped pixel elapses. Similarly, the pixel which fails in the depth test and for which rasterization is to be stopped is a pixel that does not need to perform the following processes for determining the color of the pixel. Accordingly, if this pixel is transferred to the pixel processing unit 110, the time and power spent processing this pixel are wasted. Even though this pixel is processed, the color of this pixel is ultimately not determined, and thus the pixel may lower the throughput of the pixel processing unit 110.

According to the conventional technology, a scanline generated in the scan conversion unit 100 is transferred directly to the pixel processing unit 110. Accordingly, the pixels included in the scanline may include pixels whose colors do not need to be determined.

### SUMMARY

ne or more embodiments of the present invention provide a method, medium, and system rendering a 3-dimensional (3D) object capable of improving the performance of processing a series of processes for determining colors performed using a pipeline method, by removing pixels that do not require the performance of color determining processes, from all the pixels forming a 3D object, thereby determining a series of colors only for the remaining pixels.

Additional aspects and/or advantages of the invention will be set forth in part in the description which follows and, in part, will be apparent from the description, or may be learned by practice of the invention.

To achieve at least the above and/or other aspects and advantages, embodiments of the present invention include a method of rendering a 3-dimensional (3D) object, including selectively removing pixels included in a generated scanline in consideration of visibility of respective pixels to generate a reconstructed scanline, and determining and storing respective colors for pixels included in the reconstructed scanline.

To achieve at least the above and/or other aspects and advantages, embodiments of the present invention include a system rendering a 3D object, including a scanline reconstruction unit to selectively remove pixels included in a generated scanline in consideration of visibility of respective pixels to generate a reconstructed scanline, and a pixel processing unit to determine respective colors for pixels included in the reconstructed scanline.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional rasterization engine;

FIGS. 2A through 2D illustrate an operation of the scan conversion unit illustrated in FIG. 1;

FIG. 3 illustrates an operation of the depth test unit illustrated in FIG. 1;

FIGS. 4A and 4B illustrate a process performed by the pixel processing unit illustrated in FIG. 1 operating according to a pipeline architecture;

FIGS. 5A and 5B illustrate a process performed by a pixel processing unit, in which a processing sequence is changed, operating according to a pipeline architecture;

FIG. 6A illustrates a system rendering a 3D object, according to an embodiment of the present invention;

FIG. 6B illustrates a scanline reconstruction unit, such as that illustrated in FIG. 6A, according to an embodiment of the present invention;

FIGS. 7A through 7C illustrate a comparison unit, such as that illustrated in FIG. 6B, according to embodiments of the present invention;

FIG. 8 illustrates a method of rendering a 3D object, according to an embodiment of the present invention;

FIG. 9 illustrates an operation for reconstructing a scanline, such as illustrated in FIG. 8, according to an embodiment of the present invention; and

FIG. 10 illustrates an operation for reconstructing a scanline, such as illustrated in FIG. 8, according to another embodiment of the present invention.

### DETAILED DESCRIPTION EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

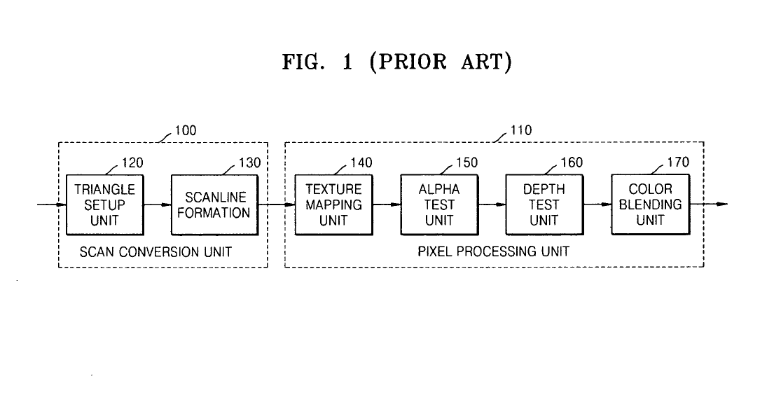

First, a series of processes included in rasterization will now be explained in detail with reference to FIGS. 1 through 5.

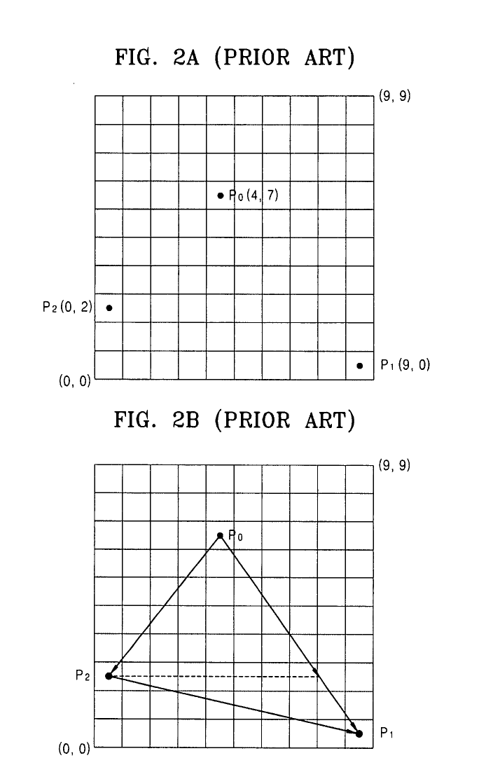

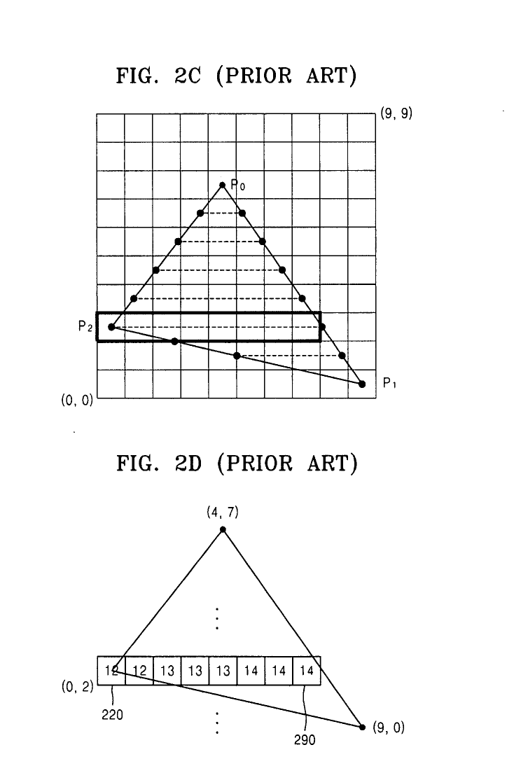

The illustrated scan conversion unit 100 includes the triangle setup unit 120 and the scanline formation unit 130. FIGS. 2A through 2D further illustrate a process in which the scan conversion unit 100 generates scanlines of a triangle.

The triangle setup unit 120 performs preliminary processing required for the scanline formation unit 130 to generate scanlines.

The triangle setup unit 120 binds all three vertices of a 3D object, thereby setting up a triangle. FIG. 2A illustrates the vertices of a 3D object transferred to the triangle setup unit 120.

The triangle setup unit 120 obtains a variety of increment values, including depth values and color values between each vertex, based on the coordinate values, color values, and texture coordinates of three vertices of one triangle, and by using the increment values, obtains three edges forming the triangle. FIG. 2B illustrates the three edges of a triangle obtained by using increment values calculated based on a variety of values with respect to each vertex.

The scanline formation unit 130 generates scanlines of a triangle in order to obtain pixels inside the triangle e.g., by using pixels positioned on the same line of pixel lines of a screen, from among pixels inside the triangle. FIG. 2C further illustrates scanlines of the triangle generated in the scanline formation unit 130, and FIG. 2D illustrates one scanline from among the scanlines illustrated in FIG. 2C together with the depth value of each pixel.

The scanline generation unit 130 transfers the generated scanlines to the pixel processing unit 110.

The illustrated pixel processing unit 110 includes the texture mapping unit 140, the alpha test unit 150, the depth test unit 160, and the color blending unit 170.

The texture mapping unit 140 performs texture mapping expressing the texture of a 3D object in order to increase a realistic effect of the 3D object.

Texture mapping is a process in which texture coordinates corresponding to an input pixel are generated, and based on the coordinates, a texel corresponding to the coordinates is fetched so as to form texture. Here, the texel is a minimum unit of the 3D object for forming texture in two dimensional space.

The alpha test unit 150 performs an alpha test for examining an alpha value indicating transparency of an input pixel. The alpha value is an element indicating the transparency of each pixel. The alpha value of each pixel is used for alpha blending. Alpha blending is one of a plurality of rendering techniques expressing a transparency effect of an object, by mixing a color on a screen with a color in a frame buffer.

The depth test unit 160 performs a depth test for examining visibility of each input pixel. The depth test is a process in which the depth value of each input pixel is compared with the depth value in a depth buffer, and if the comparison result indicates that the depth value represents that the input pixel is closer to a viewpoint than a pixel represented by the depth value of the depth buffer (that is, if the depth test is successful), the depth value of the depth buffer is updated with the depth value of the input pixel.

The depth test unit 160 transfers information of pixels whose depth tests are successful, to the color blending unit 170. This information is forwarded because pixels whose depth tests are not successful are pixels that are not displayed on the screen, and do not need to be transferred to the color blending unit 170.

The color blending unit 170 then performs color blending in order to determine the color of each input pixel.

By referring to the alpha value indicating the transparency, in addition to RGB colors, the color blending unit 170 determines the accurate color of each pixel to be output, and stores the color in a frame buffer.

According to conventional techniques, the scan conversion unit 100 generates a scanline including pixels positioned on the same line along scanlines of a screen, from among pixels inside a generated triangle, for implementation in later pipeline processing and transfers the generated scanlines directly to the pixel processing unit 110 for the pipeline processing.

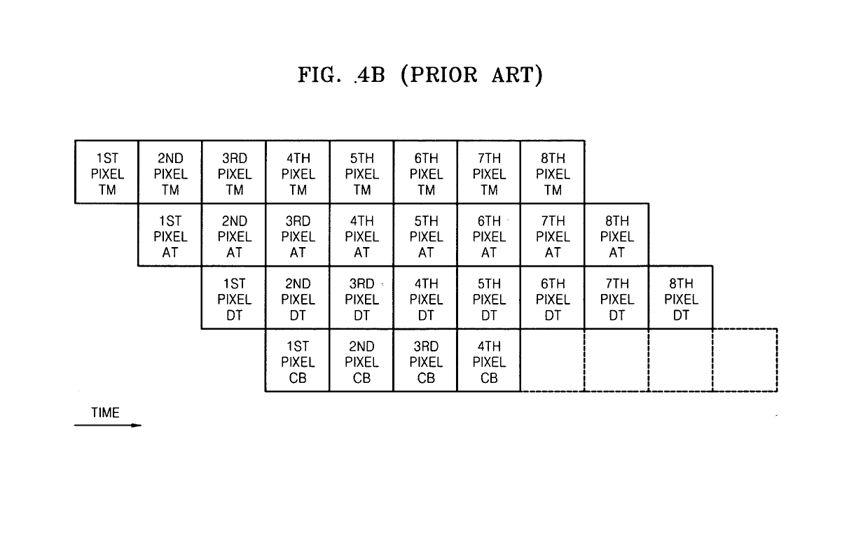

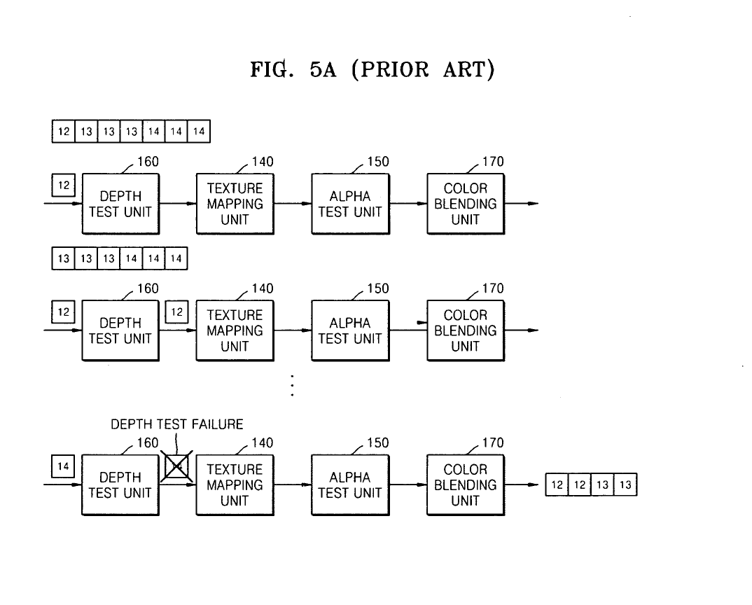

FIG. 4A further illustrates a process in which pixels 220 through 290, included in the scanline illustrated in FIG. 2D, are processed in the pixel processing unit 110 illustrated in FIG. 1. As illustrated in FIG. 4A, all pixels 220 through 290, included in the scanline illustrated in FIG. 2D, are sequentially transferred to the pixel processing unit 110, and each transferred pixel goes through the texture mapping unit 140 and the alpha test unit 150, and then, is transferred to the depth test unit 160.

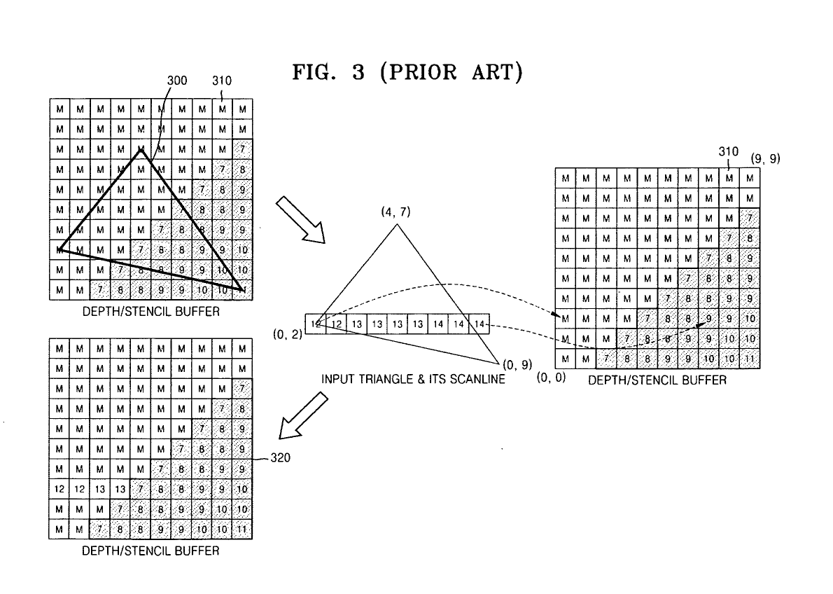

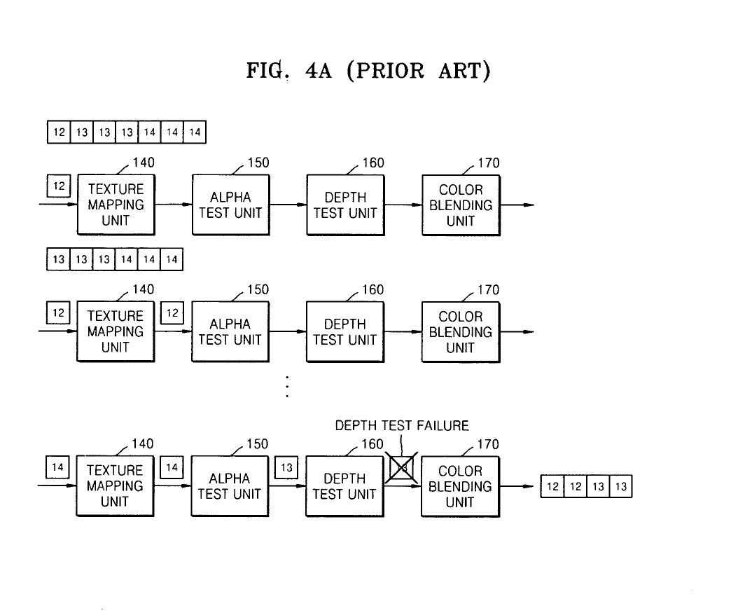

FIG. 3 illustrates a process in which the depth test unit 160 performs depth tests for the pixels 220 through 290 illustrated in FIG. 2D. The depth test unit 160 compares the depth value of each pixel included in the scanline illustrated in FIG. 2D with a corresponding depth value in the depth buffer 310. If the comparison result indicates that the pixel is closer to a viewpoint (that is, the pixel is in front of the position indicated by the depth value in the depth buffer on the screen), the depth value of the depth buffer is updated with the depth value of the pixel. A depth buffer 320 illustrated on the bottom left hand corner of FIG. 3 illustrates a state in which the depth tests for the pixels 220 through 290 included in the scanline are performed and the depth values in the depth buffer are updated with the depth values of the pixels whose depth tests are successful. Here, M indicates a maximum value among depth values that can be expressed in a depth buffer. The depth test unit 160 transfers the pixels 220 through 250 whose depth tests are successful, from among the pixels 220 through 290 included in the scanline, to the color blending unit 170, and does not transfer the remaining pixels 260 through 290 whose depth tests are not successful, to the color blending unit 170.

FIG. 4B illustrates processes in which the scanline illustrated in FIG. 2D is sequentially processed as time passed in the pixel processing unit 110 illustrated in FIG. 1. The first through fourth pixels 220 through 250, from among the pixels 220 through 290 included in the scanline, go through the texture mapping unit 140, the alpha test unit 150, the depth test unit 160, and the color blending unit 170. The color blending unit 170 finally determines the colors of the first through fourth pixels 220 through 250 in sequence.

However, the fifth through eighth pixels 260 through 290 do not pass the depth test unit 160, and thus are not transferred to the color blending unit 170. Accordingly, the color blending unit 170 remains in an idle state without producing any results for the times allocated for determining colors of the fifth through eighth pixels 260 through 290.

Thus, transferring the pixels for which processing has stopped in the middle of the processing operations, such as the fifth through eighth pixels 260 through 290, to the pixel processing unit 110 lowers the throughput of the pixel processing unit 110. In addition, power for the texture mapping and alpha testing of the fifth through eighth pixels 260 through 290, whose final results will not be generated, is also wasted.

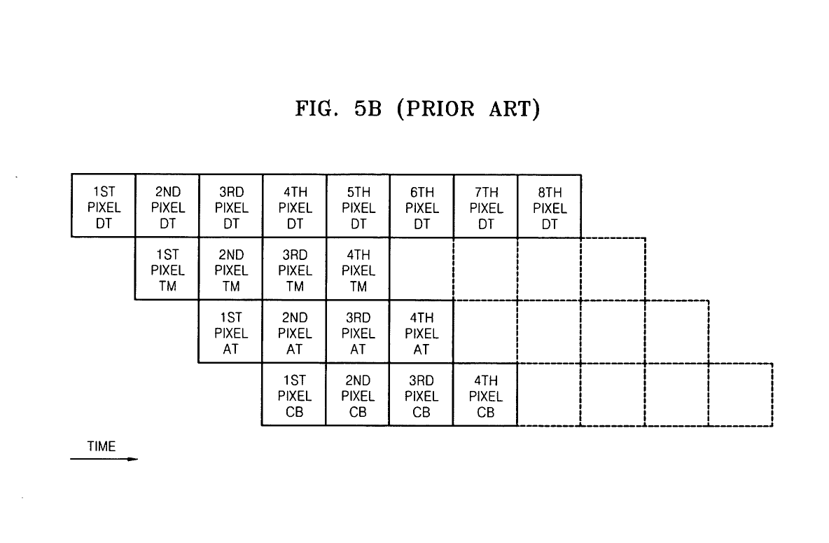

Such wasteful power consumption can be reduced by changing the sequence of processing in the pixel processing unit 110. However, the degradation of the performance of processing still remains even after the changing of the processing sequence, as the pixel processing unit 110 still operates according to a pipeline method. This continued performance degradation in processing, even when the sequence for processing in the pixel processing unit 110 has been changed, will now be explained with reference to FIGS. 5A and 5B.

As illustrated in FIGS. 5A and 5B, the pixel processing unit 110 may first perform a depth test, and then, perform texture mapping, alpha testing and color blending. In this case, with respect to the fifth through eighth pixels 260 through 290, texture mapping and alpha testing are performed, thereby reducing the power consumption for these processes. However, since the time necessary for performing texture mapping, alpha testing and color blending is already allocated for the fifth through eighth pixels 260 through 290, processing of a next pixel can be performed only after this allocated time elapses, even though the fifth through eighth pixels 260 through 290 are not processed in the texture mapping unit 140, the alpha test unit 150, or the color blending unit 170. Accordingly, during the time allocated for the fifth through eighth pixels 260 through 290, the pixel processing unit 110 does not produce any processing results, and thus the problem of performance degradation still remains.

Accordingly, according to a method, medium, and system rendering a 3D object, according to an embodiment of the present invention, unnecessary pixels from among pixels inside a triangle, for example, are removed and only the remaining pixels are transferred to the pixel processing unit 110, thereby improving the performance of rendering processes and increasing power efficiency.

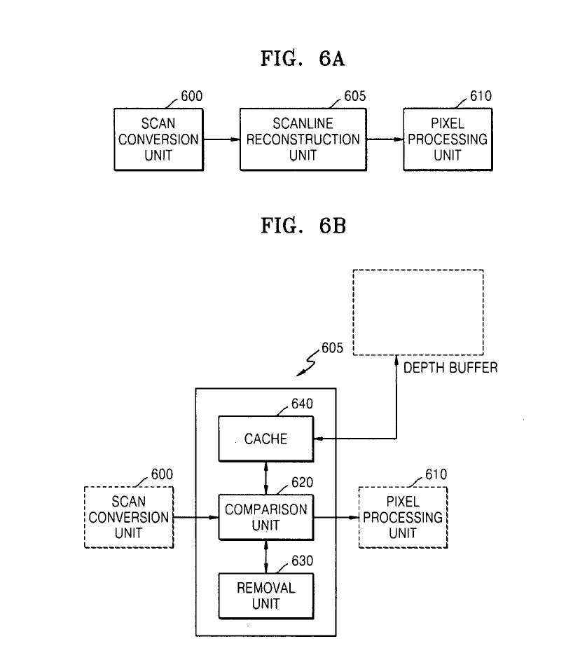

FIG. 6A illustrates a system rendering a 3D object, according to an embodiment of the present invention. The system may include a scan conversion unit 600, a scanline reconstruction unit 605, and a pixel processing unit 610, for example.

In an embodiment, the scan conversion unit 600 may set up a triangle, for example, based on input information on the triangle, generate scanlines of the set up triangle, and transfer the scanlines to the reconstruction unit 605. Here, though the triangle polygon has been discussed, alternate polygons are equally available.

The scanline reconstruction unit 605 may remove some pixels, deemed unnecessary, from among the pixels included in the transferred scanlines, thereby reconstructing scanlines, and transfer only the reconstructed scanlines to the pixel processing unit 610. A more detailed structure of the scanline reconstruction unit 605 will be explained below.

The pixel processing unit 610 may perform a series of processes for determining the color of each pixel included in the transferred scanlines. The series of processes for determining the color of the pixel may include texture mapping, alpha testing, depth testing and color blending, for example. In addition, a variety of processes for providing a realistic effect to a 3D object, such as a fog effect process, perspective correction, and MIP mapping may be included, noting that alternative embodiments are equally available.

A more detailed structure of the scanline reconstruction unit 605, according to an embodiment of the present invention, will now be explained.

FIG. 6B illustrates a scanline reconstruction unit 605, such as that illustrated in FIG. 6A, according to an embodiment of the present invention. The scanline reconstruction unit 605 may include a comparison unit 620 and a removal unit 630, and may further include a cache 640, for example.

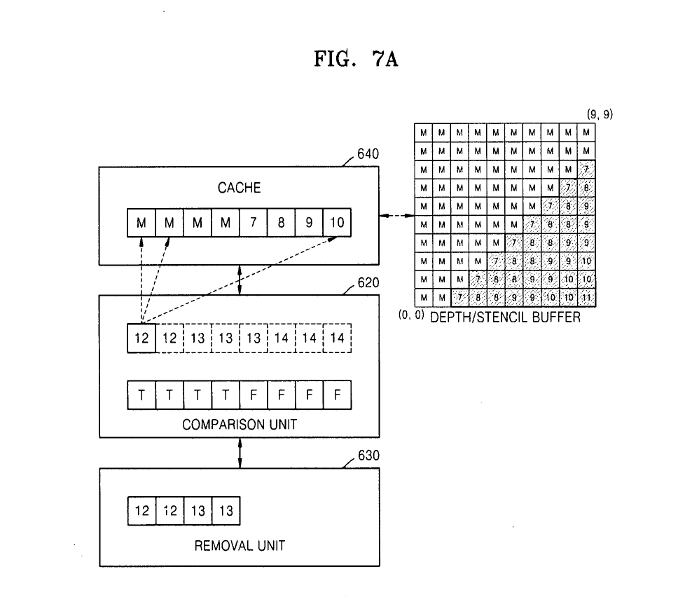

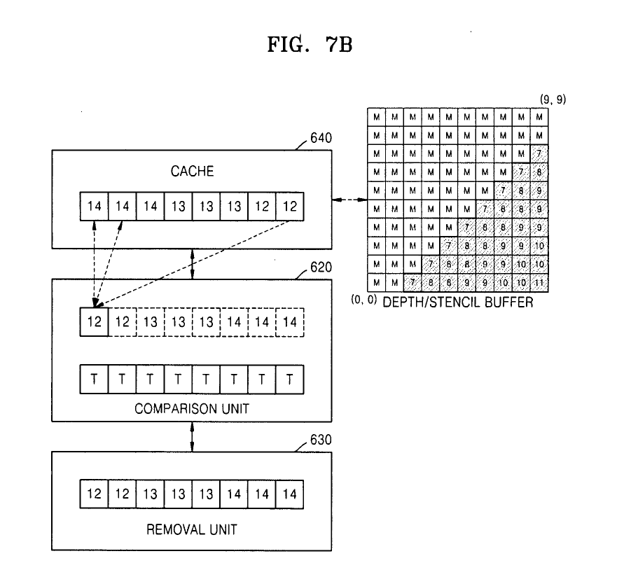

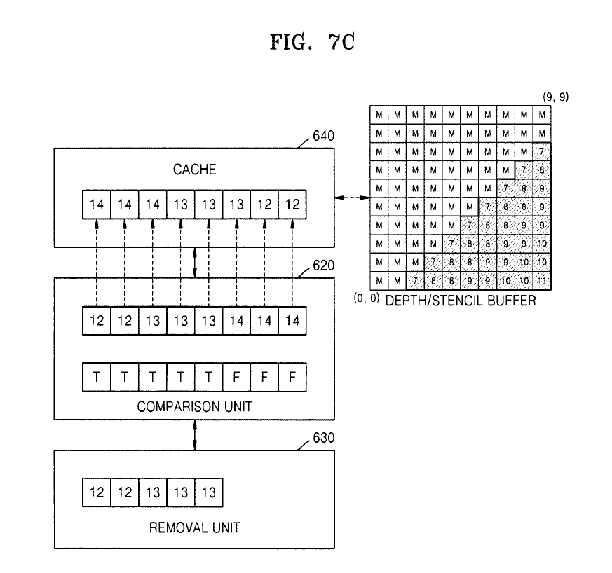

FIGS. 7A through 7C illustrates such a comparison unit 620 as that illustrated in FIG. 6B, according to one or more embodiments of the present invention. FIGS. 7A and 7B illustrate the operation of the comparison unit 620 according to an embodiment of the present invention, and FIG. 7C illustrates the operation of the comparison unit 620 according to another embodiment of the present invention. Here, similar to above, in FIGS. 7A-7C, M indicates a maximum value among depth values that can be expressed in a depth buffer.

As shown in FIG. 7A, the comparison unit 620 may compare a minimum value from among the depth values of the pixels included in the scanline transferred from the scan conversion unit 600, with the depth value stored in the depth buffer corresponding to each pixel. According to the comparison results, if the depth value in the depth buffer represents a depth closer to the screen than the minimum value of the depth values of the pixels, the depth value may be marked by T (true), for example. Similarly, according to this example, if the depth value in the depth buffer represents a depth that is not closer to the screen than the minimum value of the depth values of the pixels the depth value may be marked by F (fail).

Such a minimum value from among depth values of the pixels included in a scanline may be obtained by using the smaller value between depth values of the two end points of the scanline. Since the scanlines of a triangle are generated according to an interpolation method, the depth values of pixels included in a scanline are in a linear relationship. Accordingly, the smaller value between the depth values of two end points of the scanline can be considered the minimum value from among depth values of the pixels included in the scanline. For example, FIG. 7A illustrates a result of such a comparison in which the comparison unit 620 compares the minimum value among the depth values of the pixels included in the scanline illustrated in FIG. 2D with the depth values in the depth buffer that correspond to the pixels included in the scanline.

The comparison unit 620 may provide the comparison result to the removal unit 630. However, before transferring the comparison result to the removal unit 630, the comparison unit 620 may further determine whether a pixel to be removed exists (that is, whether a pixel marked by F exists), by referring to the comparison result.

If no pixels are to be removed, the comparison result is not transferred to the removal unit 630, and the scanline generated in the scan conversion unit 600 is directly transferred to the pixel processing unit 610, thereby reconstructing the scanline more efficiently.

According to the comparison result provided by the comparison unit 620, the removal unit 630 may remove a pixel, the depth value in the depth buffer corresponding to which represents that the pixel closer to the viewpoint than the minimum value, from among the pixels included in the scanline, thereby reconstructing a scanline. That is, from among the pixels included in the scanline transferred by the scan conversion unit 600, pixels marked by F may be removed, and a scanline is reconstructed by using only the remaining pixels marked by T, for example.

The cache 640 may be a type of high speed memory, for example. As the comparison unit 620 quickly compares the depth values stored in the depth buffer with the depth values of the scanline, the cache 640 may be used to fetch the depth values of the depth buffer corresponding to the pixels included in the scanline, and temporarily store the values.

In one embodiment, if the depth values stored in the depth buffer are compared with the minimum value from among the depth values of the pixels included in the scanline, as in the embodiment described above, some pixels that do not pass the depth test may not be removed completely.

For example, there may be a case in which the depth values stored in the depth buffer that correspond to the pixels included in a scanline are represented as illustrated in FIG. 7B.

In this case, if the minimum value from among the depth values of the pixels is compared with the depth values stored in the depth buffer, and no depth value of the depth buffer represents that the corresponding pixel is closer to the viewpoint than the minimum value, the removal unit 650 may transfer all the pixels included in the scanline, without removing any pixel. However, when the each depth value of each pixel included in the scanline is actually compared with the depth value stored in the depth buffer corresponding to the pixel, the depth values of the sixth through eighth pixels represent that these pixels are farther from the viewpoint than the depth values in the depth buffer. Accordingly, it can be determined that the sixth through eighth pixels would not pass the depth test performed in the pixel processing unit 610, for example.

As described above, according to one embodiment of the present invention, some pixels that will fail the depth test may still be transferred to the pixel processing unit 610. However, enough unnecessary pixels can still be removed to improve the performance of the pixel processing unit 610, even though all the pixels that would not pass the depth test are not removed from among the pixels included in the scanline. Further, similar to above, according such an embodiment of the present invention, the minimum value from among the depth values of the pixels included in a scanline may be compared with the depth values stored in the depth buffer that correspond to the pixels, thereby simplifying the calculation process compared with when the depth value of each pixel included in the scanline is compared with the depth value in the depth buffer corresponding to the pixel.

According to another embodiment, FIG. 7C illustrates an operation of the comparison unit 620, where comparison unit 620 compares the depth value of each pixel included in a scanline with the depth value in the depth buffer corresponding to the pixel. According to the comparison result, if the depth value of the pixel represents that the corresponding pixel is closer to the viewpoint than the corresponding depth value in the depth buffer, the depth value of the pixel may, again for example, be marked by T (true), or else, the depth value may be marked by F (fail). FIG. 7C illustrates such a comparison result in which the depth value of each pixel of the scanline illustrated in FIG. 2D is compared with the depth value of the depth buffer.

Here, the comparison unit 620 may provide the comparison result to the removal unit 630. However, before transferring the comparison result to the removal unit 630, the comparison unit 620 may determine whether a pixel to be removed exists (that is, whether or not a pixel marked by F exists), by referring to the comparison result. If no pixels are to be removed, the comparison result may not be transferred to the removal unit 630, and the scanline generated in the scan conversion unit 600 may be directly transferred to the pixel processing unit 610, thereby reconstructing the scanline more efficiently.

According to the comparison result provided by the comparison unit 620, the removal unit 630 may remove a pixel whose depth value represents that the corresponding pixel is farther from the viewpoint than the depth value in the depth buffer corresponding the pixel from among the pixels included in the scanline, thereby reconstructing a scanline. That is, from among the pixels included in the scanline transferred by the scan conversion unit 600, pixels marked by F may be removed, and a scanline reconstructed by using only the remaining pixels marked by T.

As described above, here, the depth value of each pixel included in a scanline is compared with a corresponding depth value stored in the depth buffer, thereby allowing all pixels that would not pass the depth test, to be found and removed. That is, in a stage before the pixel processing unit 610, a depth test may be performed, thereby transferring only pixels that pass the depth test, to the pixel processing unit 610. In this way, the performance of the pixel processing unit 110, operating in parallel according to a pipeline method, can be improved, and waste of the time and power consumed for processing unnecessary pixels may be prevented. Accordingly, since a depth test is performed in the scanline reconstruction unit 605, for example, in advance, the pixel processing unit 610 may be designed to not to include the depth test unit 160, for example.

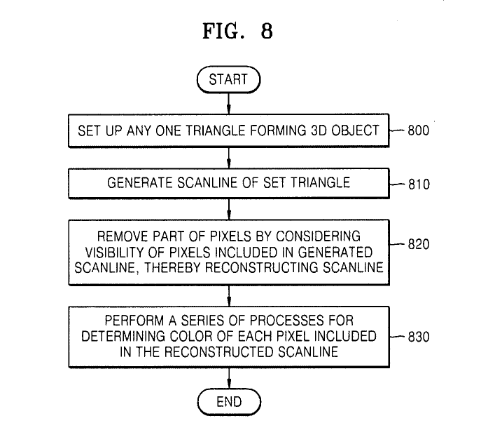

A method of rendering a 3D object according to an embodiment of the present invention will now be explained with reference to FIGS. 8 through 10.

FIG. 8 illustrates a method of rendering a 3D object, according to an embodiment of the present invention.

In operation 800, any one triangle, for example, forming a 3D object may be set up, such as discussed above with reference to the triangle setup unit 120 illustrated in FIG. 1.

In operation 810, scanlines of the set triangle may be generated, such as discussed above with reference to the scanline formation unit 130 illustrated in FIG. 1.

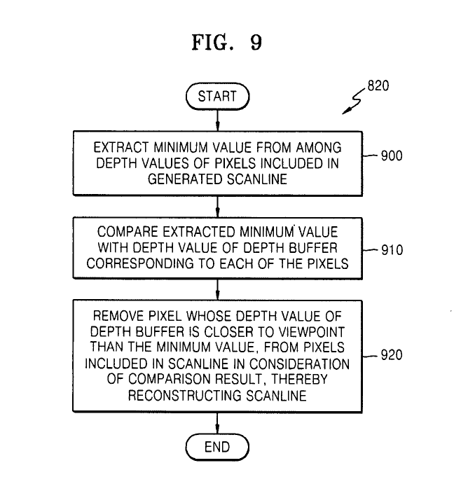

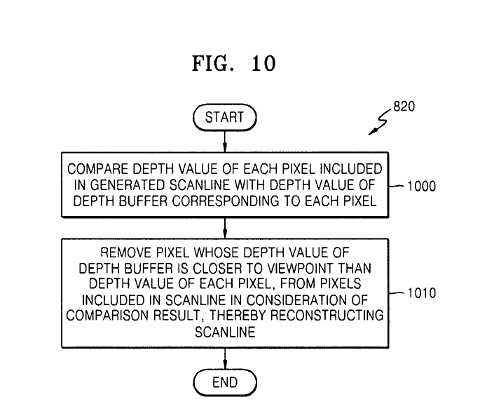

In operation 820, some pixels, from among the pixels included in the generated scanline, may be removed and/or indicated as to be removed in consideration of the visibility of the pixels, thereby reconstructing scanlines. Here, according to embodiments of the present invention, operation 820 will be discussed in greater detail below with reference to FIGS. 9 and 10.

In operation 830, a series of processes may be performed for determining the color of each pixel included in the reconstructed scanlines, such as discussed above with reference to the pixel processing unit 110 illustrated in FIG. 1. Here, the series of processes for determining the colors of the pixel may include any of texture mapping, alpha testing, depth testing and color blending, for example. In addition, a variety of processes for providing a realistic effect to a 3D object, such as a fog effect process, perspective correction, and MIP mapping, may be included, again for example.

FIG. 9 illustrates an implementation of operation 820, according to an embodiment of the present invention, reconstructing scanlines, will now be explained with reference to FIG. 9.

In operation 900, a minimum value from among the depth values of the pixels included in the scanline, e.g., as generated in operation 810, may be extracted, e.g., by the scanline reconstruction unit 605. Here, a minimum value from among depth values of the pixels included in a scanline can be obtained by using the smaller value between depth values of two end points of the scanline. Accordingly, the smaller value between the depth values of two end points of a scanline may be considered to be the minimum value from among depth values of the pixels included in the scanline.

In operation 910, the extracted minimum value may be compared with the depth value in the depth buffer corresponding to each pixel.

In operation 920, pixels, from among the pixels included in the scanline, may be removed based on the comparison of the depth value in the depth buffer representing that the corresponding pixel is closer to the viewpoint than the minimum value, by considering the result of the comparison in operation 910, thereby reconstructing a scanline, i.e., if a minimum value for the pixels in the scanline is greater than a corresponding depth value for a corresponding pixel of the depth buffer, that corresponding pixel within the scanline may be removed.

FIG. 10 illustrates an implementation of operation 820, reconstructing a scanline, according to another embodiment of the present invention.

In operation 1000, the depth value of each pixel included in the scanline, e.g., generated in operation 810, may be compared with a corresponding depth value in the depth buffer, e.g., by the scanline reconstruction unit 605.

In operation 1010, by considering the result of the comparison in operation 1000, pixels, from among the pixels included in the scanline, may be removed based upon the comparison of each corresponding depth value in each corresponding depth buffer representing that the corresponding pixel is closer to the viewpoint than the depth value of each corresponding scanline pixel, thereby reconstructing a scanline.

Thus, according an embodiment, some pixels that would fail the depth test may still be transferred for operation 830. However, even though not all failing pixels may be removed, enough unnecessary pixels can be removed to improve the performance of the series of processes in operation 830 for determining colors, even though all the pixels that cannot pass the depth test are not removed from among the pixels included in the scanline. In addition, here, a minimum value from among the depth values of the pixels included in a scanline may be compared with respective depth values stored in the depth buffer, thereby simplifying the calculation process compared with a comparing of the depth value of each pixel included in the scanline with each corresponding depth value in the depth buffer.

Further, according to an embodiment, the depth value of each pixel included in a scanline is compared with a corresponding depth value in the depth buffer, thereby allowing all pixels that would not pass the depth test to be found and removed. That is, before operation 830, for example, depth tests may be performed, thereby transferring only pixels that pass the depth test, for operation 830. In this way, the performance of the series of processes for determining colors of pixels operating in parallel, according to a pipeline method, can be improved, and conventional wastes of time and power consumed for processing unnecessary pixels can be prevented. Accordingly, conversely to conventional systems, since a depth test may be performed in operation 1000 operation 830 may be designed not to perform such a depth test in operation 830.

One or more embodiments of the present invention include a method, medium, and system reconstructing scanlines, e.g., as described above, where some unnecessary pixels from among the entire pixels included in a scanline are removed, and only the remaining pixels are transferred to a series of pipeline rendering processes, thereby improving the efficiency of the series of pipeline rendering processes performed in parallel.

In addition, one or more embodiments of the present invention include rendering method, medium, and system where unnecessary pixels from among the entire pixels included in a scanline are removed, and only the remaining pixels are transferred to a series of rendering processes, thereby improving the efficiency of the series of rendering processes performed in parallel.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as carrier waves, as well as through the Internet, for example. Thus, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of rendering a 3-dimensional (3D) object, comprising:
selectively removing pixels included in a generated scanline in consideration of visibility of respective pixels to generate a reconstructed scanline for provision to a pipeline process; and
determining and storing respective colors for pixels included in the reconstructed scanline in the pipeline process.

2. The method of claim 1, further comprising generating scanlines of a primitive forming the 3D object.

3. The method of claim 1, wherein, in the determining and storing of the respective colors for pixels included in the reconstructed scanline, a series of processes according to the pipeline process are performed for each pixel of the scanline, thereby determining the respective colors for each pixel of the scanline.

4. The method of claim 3, wherein the selectively removing of pixels included in the generated scanline comprises removing pixels for which processing would be stopped if implemented within any one of the series of processes having a depth test, according to the pipeline process.

5. The method of claim 3, wherein the selectively removing of pixels included in the generated scanline comprises removing pixels which are farther from a viewpoint than corresponding pixels of depth values in a depth buffer.

6. The method of claim 1, wherein the selective removing of pixels included in the generated scanline, comprises:
comparing at least one of respective depth values of the pixels included in the scanline with corresponding depth values stored in a depth buffer; and
removing select pixels from among the pixels included in the scanline based upon a result of the comparing of the at least one of respective depth values.

7. The method of claim 6, wherein the comparing of the at least one of the respective depth values comprises comparing a minimum value from among the respective depth values of the pixels included in the scanline with the corresponding depth values stored in the depth buffer, and the removing of the select pixels from among the pixels included in the scanline based upon the result of the comparing of the at least one of respective depth values comprises removing a pixel from the pixels included in the scanline if the minimum value compared to a corresponding depth value stored in the depth buffer indicates that the pixel is farther, from a viewpoint, than indicated by the corresponding depth value stored in the depth buffer.

8. The method of claim 6, wherein the comparing of the at least one of the respective depth values comprises comparing respective depth values of each pixel of the scanline with each corresponding depth value stored in the depth buffer, and the removing of the select pixels from among the pixels included in the scanline is based upon respective results of the comparing of each of respective depth values and comprises removing a pixel from the pixels included in the scanline if a depth value of the pixel compared to a corresponding depth value stored in the depth buffer indicates that the pixel is farther, from a viewpoint, than indicated by the corresponding depth value stored in the depth buffer.

9. The method of claim 1, further comprising, with respect to all primitives forming the 3D object, repeatedly selectively removing pixels included in respective generated scanlines in consideration of visibility to generate respective reconstructed scanlines, and determining of colors of each respective pixel included in the respective reconstructed scanlines.

10. At least one medium comprising computer readable code to control at least one processing element to implement the method of claim 1

11. A system rendering a 3D object, comprising:
a scanline reconstruction unit to selectively remove pixels included in a generated scanline in consideration of visibility of respective pixels to generate a reconstructed scanline for provision to a pipeline process; and
a pixel processing unit to determine respective colors for pixels included in the reconstructed scanline in the pipeline process.

12. The system of claim 11, further comprising a scan conversion unit to generate scanlines of a primitive forming the 3D object.

13. The system of claim 11, wherein the pixel processing unit performs a series of processes according to the pipeline process for each pixel of the scanline, thereby determining the respective colors for each pixel.

14. The system of claim 13, wherein the scanline reconstruction unit selectively removes pixels for which processing would be stopped if implemented within any one of the series of processes having a depth test, according to the pipeline process.

15. The system of claim 11, wherein the scanline reconstruction unit comprises:
a comparison unit to compare at least one of respective depth values of the pixels included in the scanline with corresponding depth values stored in a depth buffer; and
a removal unit to selectively remove select pixels from among the pixels included in the scanline according to a result of the comparison unit.

16. The system of claim 15, wherein the comparison unit compares a minimum value from among the respective depth values of the pixels included in the scanline with the corresponding depth values stored in the depth buffer, and the removal unit removes the select pixels from the pixels included in the scanline by removing a select pixel if the minimum value compared to a corresponding depth value stored in the depth buffer indicates that the pixel is farther, from a viewpoint, than indicated by the corresponding depth value stored in the depth buffer

17. The system of claim 15, wherein the comparison unit compares respective depth values of each pixel of the scanline with each corresponding depth value stored in the depth buffer, and the removal unit removes the select pixels from the pixels included in the scanline by removing a select pixel if a depth value of the pixel compared to a corresponding depth value stored in the depth buffer indicates that the pixel is farther, from a viewpoint, than indicated by the corresponding depth value stored in the depth buffer.
